(19) United States
(12) Patent Application Publication
(10) Pub. No.: US 2011/0231934 A1
(43) Pub. Date: Sep. 22, 2011

(54) Distributed Virus Detection

(75) Inventors: Trent Davis, Spring Hill (AU); James Peter Brotchie, Toowong (AU); Stephen James Thorne, Greenslopes (AU)

(73) Assignee: Agent Smith Pty Ltd, Spring Hill Queensland (AU)

(21) Appl. No.: 13/131,006

(22) PCT Filed: Nov. 24, 2009
(86) PCT No.: PCT/AU2009/001536

§ 371 Date: May 24, 2011

(30) Foreign Application Priority Data
Nov. 25, 2008 (AU) 2008906087

(51) Int. Cl. G06F 11/30; G06F 15/173

(52) U.S. Cl. 726/24

(57) ABSTRACT

A method and system for efficient virus protection in networks of computing resources. Virus definitions are ranked and distributed according to activity. Active viruses are scanned for by substantially every computing resource in the network but scanning for less active virus is distributed across the network according to computing resource capacity.

### FIELD OF THE INVENTION

The invention relates to an improved method of virus detection for computer systems and virus detection hardware embodying the method. The invention is applicable to client-server and peer-to-peer networks of computers.

### BACKGROUND TO THE INVENTION

It is well known that computer systems that are connected to networks are subject to infection by malicious programs, commonly referred to as viruses. The problem is particularly significant for computers connected to the Internet.

The Internet is an extended network of connectivity between computing resources. For most users the Internet is accessed by connecting to an Internet Service Provider, which is a server, or cluster of servers, that deliver Internet services via communication protocols. The communication channel is most commonly wire (telephone lines) but is more frequently becoming wireless (radio frequency).

The Internet is designed for free exchange of data between connected computing nodes. The intrinsic open architecture of the Internet makes malicious interference with computer operations relatively simple. To combat the proliferation of viruses various anti-virus methodologies have been developed. These include hardware and software solutions. A common approach is to scan computer memory for changes that are unexpected or unauthorised. Another approach is to identify unexpected executable program code and scan for malicious activity. These techniques require significant computing resources that are beyond the scope of most home and small business computers. One way of addressing the need for significant computing capacity is to subscribe to a service that identifies viruses and provides a list of virus signatures (or definitions) that are used to quickly scan computing resources for viruses. This approach significantly reduces the load on individual computers. This approach has been successfully implemented in software and firmware by the vendors of such well known products as Symantec, McAfee and Trend Micro.

Despite the success of these known solutions the rate of emergence of new viruses challenges the capacity of the solutions to cope. In order to scan for viruses the anti-virus solutions must maintain a library of virus signatures. Typically the solutions update the virus signatures daily and scan the computing resource to identify the presence of any of the known signatures. This has proven to be insufficient to provide practical protection so most systems also provide continuous protection. For a typical home desktop computer the number of virus signatures to be scanned presents a significant resource load. The result is that the cost of computer security is a significant load on computing resources, sometimes to the extent that the computer is no longer useful and upgrade is required. It is a source of frustration for many users that operation of improved software requires a hardware upgrade and a hardware upgrade requires improved software, so there is a constant cycle of expense for upgrades.

### OBJECTS OF THE INVENTION

It is an object of the present invention to overcome or at least alleviate one or more of the above limitations.

It is a further object of the present invention to provide a method of monitoring for computer viruses that reduces the computing load on individual machines.

### SUMMARY OF THE INVENTION

In one form, although not necessarily the only or indeed the broadest form, the invention resides in a method of detecting computer viruses in a network of computing resources including the steps of:

receiving virus definitions;
determining the most active viruses;
allocating scanning for the most active viruses to substantially every computing resource; and
distributing scanning for other viruses between computing resources.

In a further form the invention resides in a distributed computing environment for virus detection comprising:

a plurality of computing resources linked in a communication network;
a communication channel to a virus definition provider; and
means for managing allocation of virus definitions to computing resources;
wherein active virus definitions are allocated to substantially every computing resource and less active virus definitions are distributed between computing resources.

Further features and advantages of the present invention will become apparent from the following detailed description.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, in which:

FIG. 1 is a sketch of a computing environment;

FIG. 2 is a schematic representation of the allocation of virus scanning to computing resources;

FIG. 3 is a sketch of an alternate computing environment;

FIG. 4 is a sketch of a server in the alternate computing environment; and

FIG. 5 is a flowchart of a method of distributed virus scanning.

### DETAILED DESCRIPTION OF THE INVENTION

Embodiments of the present invention reside primarily in a distributed virus detection network and a method of implementing distributed virus detection. Accordingly, the method steps have been illustrated in concise schematic form in the drawings, showing only those specific details that are necessary for understanding the embodiments of the present invention, but so as not to obscure the disclosure with excessive detail that will be readily apparent to those of ordinary skill in the art having the benefit of the present description.

In this specification, adjectives such as first and second, left and right, and the like may be used solely to distinguish one element or action from another element or action without necessarily requiring or implying any actual such relationship or order. Words such as “comprises” or “includes” are intended to define a non-exclusive inclusion, such that a process, method, article, or apparatus that comprises a list of elements does not include only those elements but may include other elements not expressly listed, including elements that are inherent to such a process, method, article, or apparatus.

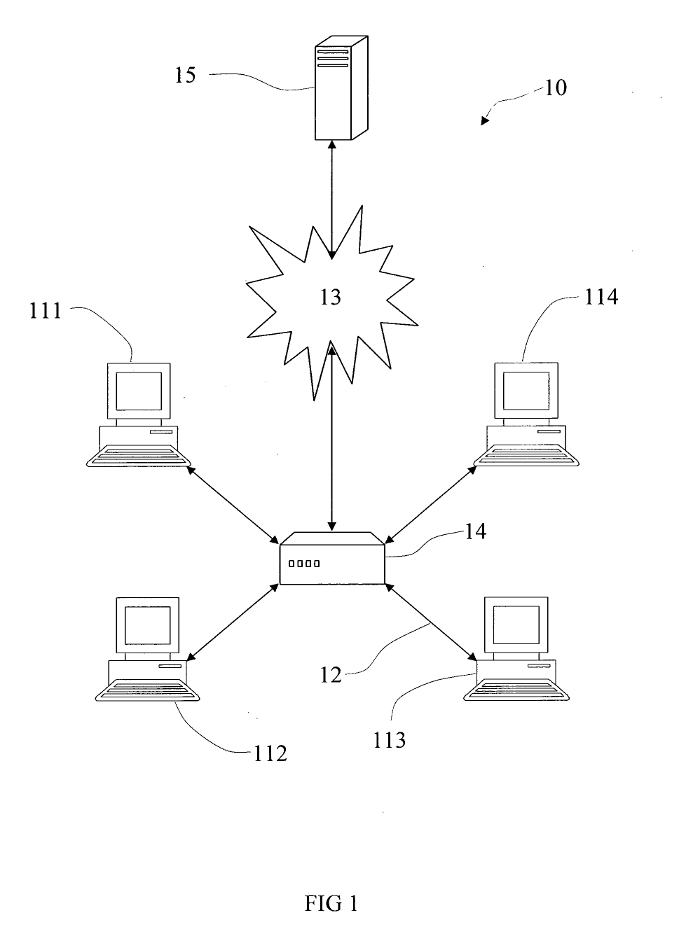

Referring to FIG. 1 there is a shown a distributed virus detection network 10 comprising a number of client computers, such as 111, 112, 113, 114. The client computers are typically connected via a peer-to-peer local area network 12. A local area network of this nature is typical of a home network or a small business network.

The client computers access external resources via the internet 13 using a gateway appliance 14. A typical gateway appliance 14 is a broadband ADSL modem or a cable modem. The gateway device 14 may also incorporate a router and may be wireless or wired. Persons skilled in the art will be familiar with suitable gateway devices.

Each client computer has antivirus software installed and is able to independently download virus definitions from a supplier server 15. If each client computer independently checks for viruses the total load in the network is many times greater than is necessary since there is duplication of processing and therefore redundancy. The inventors have realised that viruses will move quickly from computer to computer within the local area network and therefore it can be assumed that a virus found on one computer is likely to be also found on the other computers. To state the converse, it is only necessary to scan one computer to identify viruses likely to be on all the computers.

Furthermore, the inventors have realised that the vast majority of identified viruses have very low activity. In other words, the likelihood of most viruses being found is very low. The inventors speculate that perhaps only 10% to 20% of known viruses should be considered as active and therefore likely to be identified. It is therefore effective for substantially every client computer to monitor for the 10-20% of active viruses and to distribute the monitoring of the other 80-90% of viruses amongst the client computers.

The determination of whether a virus is active may be a user defined activity. For instance, a virus would be considered “active” if it is detected at least once on the network. The detection information is aggregated, then the “active” list is pushed out using a suitable algorithm.

When it is stated that substantially every client computer monitors for the 10-20% of active viruses persons skilled in the art will understand that it is only necessary to monitor for viruses on client computers that have some likelihood of being infected by the virus. So, for instance, a ‘passive’ client computer that does not run executables or other devices, such as a network aware television receiver, would not scan for viruses.

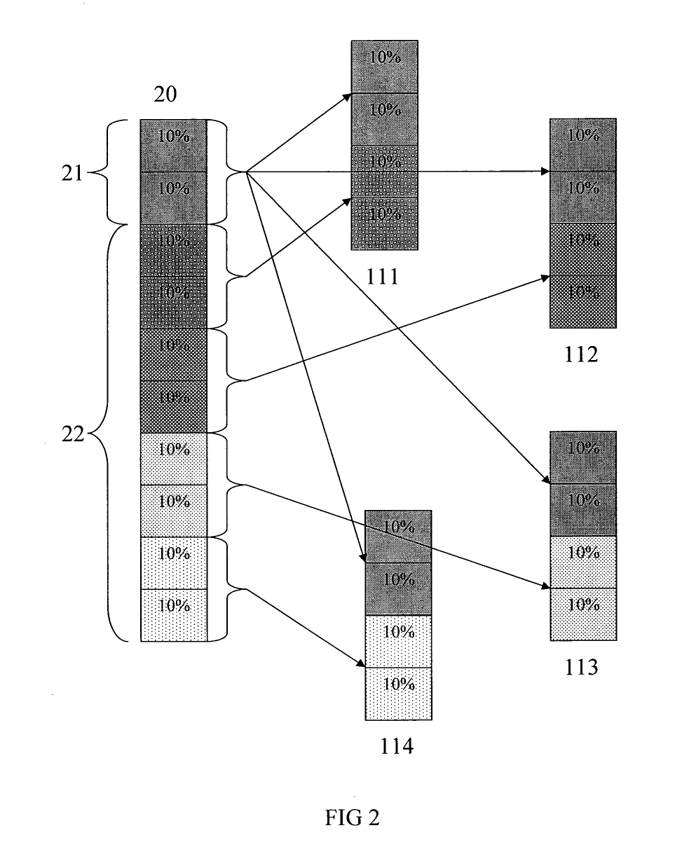

The distributed virus detection concept is shown conceptually in FIG. 2. A set of virus definitions 20 may have a top twenty percent 21 that are active and have a reasonable likelihood of being found in a scan. The remaining eighty percent 22 are much less likely to be found in a virus scan. It is an inefficient use of resources for all four client computers 111-114 to scan continuously for all virus definitions 20. To improve efficient use of computing resources the scanning load is distributed across all client computers. In one preferred embodiment the top twenty percent of active virus definitions are allocated to every client computer. Thus client computer 111 will scan for virus definitions 21. Similarly, client computer 112 will also scan for virus definitions 21, as will client computers 113 and 114. The remaining eighty percent of virus definitions are distributed between the client computers. Thus, in the example, client computer 111 will scan for the next twenty percent of viruses, client computer 112 the next twenty percent, etc.

The distribution of virus definitions is arbitrary and configurable. In certain circumstances it may be appropriate to only allocate the top ten percent of active viruses to all computers and to distribute the remaining ninety percent. It may also be appropriate to distribute unevenly such that a computer that has a low resource usage will scan for viruses with a higher probability of activity whereas a low-end computer or a computer with high resource utilisation may not scan for any additional viruses.

The distribution of virus definitions between computing resources may be static in the sense that it is initialized at installation and is unchanging. In an alternate embodiment the distribution is dynamic and determined by management software that allocates virus definitions according to measured resource availability. The management software may run on a processor in the gateway appliance or on one of the computers in the network. In a further embodiment the distribution of virus definitions is user controlled via a user interface, such as the configuration interface commonly used with known gateway appliances.

The management software would periodically aggregate the information from the computers, including detected viruses (active viruses) and their relative system load. Each computer could, for example, have a regular interval for sending information to the management software, and downloading the current definitions required. Alternatively, the management software may contact each computer on a schedule to send and retrieve this information. The centralised information can then be used to decide which system should get which definitions—including factors such as available computing capacity, active viruses and no longer active viruses.

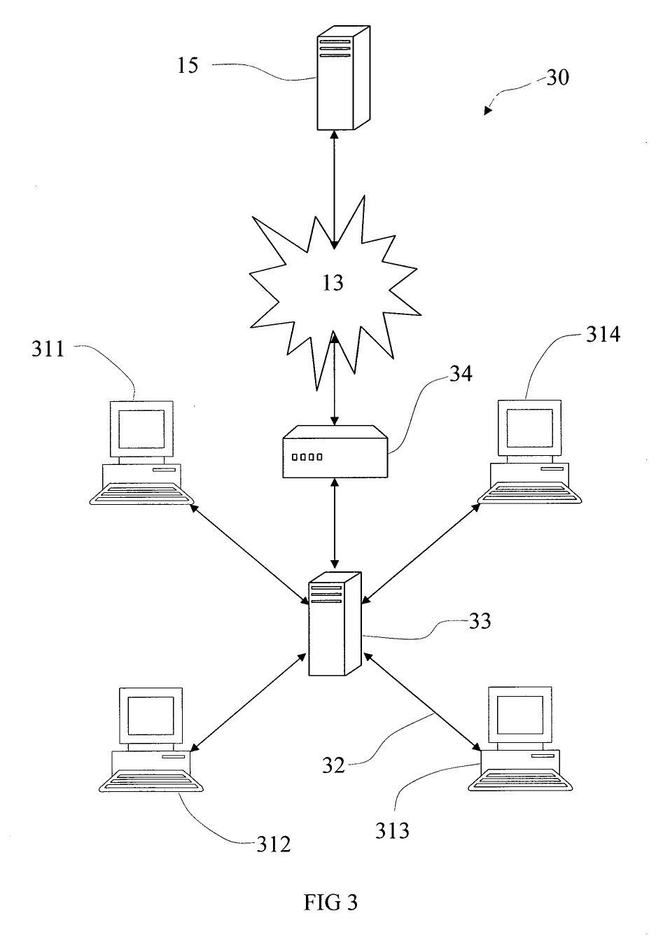

The invention is not limited to a peer-to-peer network implementation. It may also be applied in a client-server environment of the type displayed in FIG. 3. Referring to FIG. 3 there is a shown a distributed virus detection network 30 comprising a number of client computers, such as 311, 312, 313, 314. The client computers are typically connected via a client-server local area network 32. A local area network of this nature is typical of a small to medium business.

The client computers access external resources via the server 33 which access the Internet using a gateway appliance 34. A typical gateway appliance 34 provides firewall services as well as spam filtering and virus checking.

Each client computer has antivirus software installed and receives virus definitions from the server 33 which are obtained from the supplier server 15. The server 33 runs management software that distributes virus scanning to client computers depending on the resource load of each client computer 31. As mentioned above, the allocation may be static, configurable or dynamic.

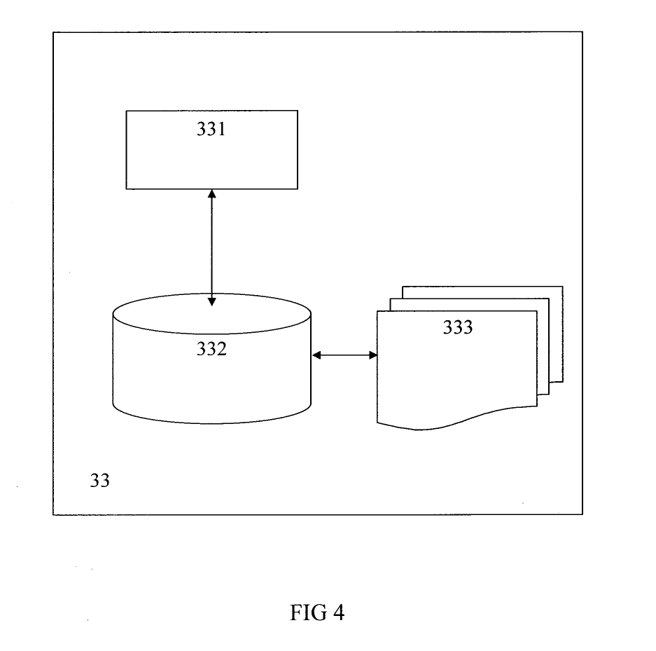

By way of example for the client-server implementation, the server 33 may comprise a processor 331 operatively coupled to a storage medium in the form of memory 332, as shown in FIG. 4. Memory 332 comprises a computer readable medium, such as a read only memory (e.g., programmable read only memory (PROM), or electrically erasable programmable read only memory (EEPROM)), a random access memory (e.g. static random access memory (SRAM), or synchronous dynamic random access memory (SDRAM)), or hybrid memory (e.g., FLASH), or other types of memory as are well known in the art. Memory 332 comprises computer readable program code components 333 for detecting computer viruses in accordance with the teachings of the present invention. At least some of computer readable program code components 333 are selectively executed by the processor 331 and are configured to cause the execution of the embodiments of the present invention described herein.

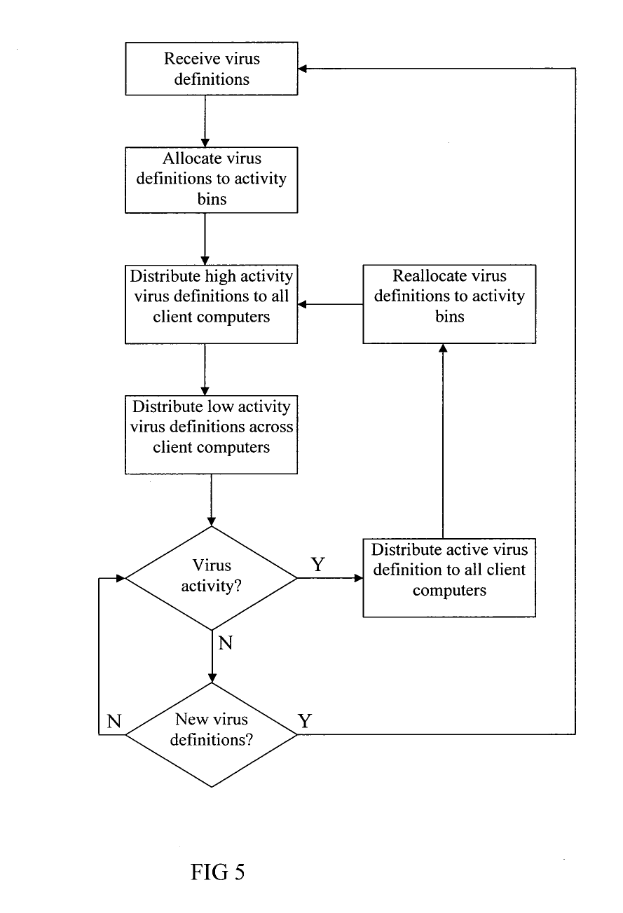

The process of distributed virus detection is outlined in the flowchart of FIG. 5. The process commences when a virus definition file is received. As discussed above, this may be received at a gateway appliance, a server or one of the computers in a peer-to-peer network. The virus definitions are allocated to activity bins. This may be initialized by the virus signature provider or by some other criteria, such as age or potency. It will be appreciated that the allocation changes over time depending on virus activity.

The high activity virus definitions are distributed to every computer that is at risk of virus infection. The low activity virus definitions are distributed between the available computing resources. If virus activity is detected amongst the low activity definitions the active virus definition is immediately distributed to all computers which then use the definitions in virus scanning. The newly found active definition is promoted from an inactive bin to the active bin and redistribution occurs.

Periodically new virus definitions are received. Any new virus definitions are allocated to the high activity bin but may be moved to a low activity bin if no activity is measured within a stipulated time period.

Although the embodiments described above are simple it will be appreciated that the invention is not limited to a network of three or four computers. The embodiments are simplified for ease of description. In practice the networks may contain hundreds of computing resources. In fact, the invention can be applied to virus detection across the internet with virus checking distributed dynamically between thousands of computers. Each computer could contact a central “cloud” based management software system to get updates and send relevant information. This could also be deployed utilising a peer-to-peer type technology such as BitTorrent to reduce the load on a central system.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above described invention.

1. A method of detecting computer viruses in a network of computing resources including the steps of:
receiving virus definitions;
determining the most active viruses;
allocating scanning for the most active viruses to substantially every computing resource; and
distributing scanning for other viruses between computing resources.

2. The method of claim 1 wherein the virus definitions are received from a virus definition provider.

3. The method of claim 1 wherein the virus definitions are received with an activity index.

4. The method of claim 1 further including the step of ranking the virus definitions according to activity to produce an activity index.

5. The method of claim 3 or 4 wherein the step of determining the most active viruses includes determining the viruses with the highest activity index.

6. The method of claim 1 wherein distribution of scanning for other viruses is dynamically based on computing resource load.

7. The method of claim 1 wherein distribution of scanning for other viruses is static.

8. The method of claim 1 wherein distribution of scanning for other viruses is non-uniformly distributed across computing resources.

9. The method of claim 1 further including the step of setting the distribution of scanning for other viruses via a user interface.

10. A distributed computing environment for virus detection comprising:
a plurality of computing resources linked in a communication network;
a communication channel to a virus definition provider; and
means for managing allocation of virus definitions to computing resources;
wherein active virus definitions are allocated to substantially every computing resource and less active virus definitions are distributed between computing resources.

11. The distributed computing environment of claim 10 wherein the plurality of computing resources have different computing resource capacity and/or different computing load.

12. The distributed computing environment of claim 10 wherein the communication network is a peer-to-peer network.

13. The distributed computing environment of claim 10 wherein the communication network is a client-server network.

14. The distributed computing environment of claim 10 wherein the means for managing allocation of virus definitions is firmware in a gateway appliance.

15. The distributed computing environment of claim 10 wherein the means for managing allocation of virus definitions is software in a computing resource.

16. The distributed computing environment of claim 10 wherein less active virus definitions are distributed between computing resources according to computing resource capacity.
